(19) United States
(12) Patent Application Publication
(10) Pub. No.: US 2026/0259721 A1
(43) Pub. Date: Sep. 3, 2026

(54) METHODS AND SYSTEMS FOR DYNAMIC PRE-INSTALLATION OF APPLICATIONS

(71) Applicant: T-Mobile Innovations LLC, Overland Park, KS (US)

(72) Inventors: Erica Dawn CHRISS, Seattle, WA (US); Billy Gene MCCRACKEN, JR., Lenexa, KS (US)

(21) Appl. No.: 19/067,478

(22) Filed: Feb. 28, 2025

(51) Int. Cl. G06F 8/61

(52) U.S. Cl. CPC G06F 8/61

(57) ABSTRACT

A method comprises receiving a request from a user equipment (UE) comprising diagnostic data and network data associated with the UE, transmitting, to the UE, a custom manifest describing one or more applications for pre-installation and links to install the one or more applications at the UE, wherein the one or more applications are optimally selected based on the diagnostic data, the network data, and at least one of billing data describing an account associated with the UE, or user data describing data, media, or interactive elements that a user or user segment has engaged with across different applications, and transmitting, to the UE, an updated manifest describing one or more additional applications to recommend for installation at the UE.

### CROSS-REFERENCE TO RELATED APPLICATIONS

None.

### STATEMENT REGARDING FEDERALLY SPONSORED

### RESEARCH OR DEVELOPMENT

Not applicable.

### REFERENCE TO A MICROFICHE APPENDIX

Not applicable.

### BACKGROUND

Telecommunications carriers pre-install applications on devices to enhance the user experience, promote carrier-specific services, and generate revenue through partnerships. These pre-installed applications may include essential carrier tools and third-party applications. Applications may be pre-installed on a device either during manufacturing or during the Out-of-Box Experience (OOBE). In the manufacturing stage, the original equipment manufacturer (OEM) embeds core applications directly into the device firmware or as application packages on the system. During OOBE, when the user powers on the device for the first time, the device may connect to the backend of a carrier network or another platform to install the applications.

### SUMMARY

In an embodiment, a method for dynamically pre-installing one or more applications at a user equipment (UE). The method comprises receiving, by a pre-installation application executing at an application system, a request from the UE, in which the request comprises diagnostic data and network data associated with the UE, and the diagnostic data describes an attribute of the UE, and wherein network data describes a location of the UE and a type of network connected to the UE. The method comprises determining, by the pre-installation application using an identification application associated with a trained data model application and executing at a data processing system, a user identifier of a user operating the UE based on at least one of the diagnostic data and billing data associated with the UE and obtained using the diagnostic data, and associating, by the pre-installation application, user data describing an application history of the user, the diagnostic data, the network data, and the billing data with the user identifier of the user. The method further comprises transmitting, by the pre-installation application using a pre-loading application associated with the trained data model application and executing at the data processing system, to the UE, a custom manifest including data describing the one or more applications to pre-install at the UE and links for installing the one or more applications, in which the one or more applications are optimally selected based on the user data, the diagnostic data, the network data, and the billing data, selecting, by the pre-installation application using a selection application associated with the trained data model application and executing at the data processing system, additional applications to recommend for installation at the UE based on post-setup engagement data describing a usage of installed applications at the UE over a predefined period of time after setup of the UE, and transmitting, by the pre-installation application, to the UE, an updated manifest including data describing the additional applications and links for installing the additional applications.

In an embodiment, a communication system is disclosed. The communication system comprises one or more non-transitory memories, one or more processors communicatively coupled to the one or more non-transitory memories, a pre-installation application stored at a first non-transitory memory, and a data model application stored at a second non-transitory memory. The pre-installation application, when executed by a first processor, causes the first processor to be configured to train a data model application using training data, in which the training data comprises labelled datasets including historical data describing associations between users and content that the users have engaged with across different applications. The data model application, when executed by a second processor, causes the second processor to be configured to receive a request from a UE, in which the request comprises diagnostic data and network data associated with the UE, and the diagnostic data describes one or more attributes of the UE, and wherein network data describes a location of the UE and a network connected to the UE, and determine one or more applications for pre-installation at the UE based on the diagnostic data, the network data, billing data describing an account associated with the UE, and user data describing data, media, or interactive elements that a user or user segment has engaged with across different applications. The pre-installation application is configured to generate a custom manifest including data describing the one or more applications to pre-install at the UE and links for installing the one or more applications, and transmit the custom manifest to the UE.

In yet another embodiment, a method is disclosed. A method comprises receiving, by a pre-installation application executing an application system, a request from a user equipment (UE), wherein the request comprises diagnostic data and network data associated with the UE, transmitting, by the pre-installation application using a data model application executing at a data processing system, to the UE, a custom manifest describing one or more applications for pre-installation and links to install the one or more applications at the UE, wherein the one or more applications are optimally selected based on the diagnostic data, the network data, and at least one of billing data describing an account associated with the UE, or user data describing data, media, or interactive elements that a user or user segment has engaged with across different applications, and transmitting, by the pre-installation application using the data model application, to the UE, an updated manifest describing one or more additional applications to recommend for installation at the UE based on post-setup engagement data describing a usage of installed applications at the UE over a predefined period of time after setup of the UE.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication system for the dynamic pre-installation of applications at UEs according to an embodiment of the disclosure.

FIG. 2 is a diagram illustrating the training of a data model for the dynamic pre-installation of applications at UEs according to various embodiments of the disclosure.

FIG. 3 is a diagram illustrating the use of the data model for the dynamic pre-installation of applications at UEs according to various embodiments of the disclosure.

FIG. 4 is a message sequence diagram illustrating a method for dynamically pre-installing applications at a UE according to various embodiments of the disclosure.

FIG. 5 is a flowchart of a first method of dynamically pre-installing applications at a UE according to various embodiments of the disclosure.

FIG. 6 is a flowchart of a second method of dynamically pre-installing applications at a UE according to various embodiments of the disclosure.

FIG. 7 is a block diagram of a computer system implemented within the communication system of FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The OOBE mentioned above refers to the sequence of steps a user encounters where powering on a user equipment (UE) (e.g., a cell phone) for the first time. During this process, the UE may first power on the UE to initiate the operating system, and at this stage, any applications included with the firmware of the UE may already be installed at the UE upon powering-on. The user of the UE may then be prompted to connect to a Wi-Fi network or enable mobile data. The UE may then connect to a telecommunications core network to validate the subscribe identity module (SIM) (e.g., either the physical SIM card or the electronic SIM profile) to activate the UE, and the core network may push specific settings or configurations to the UE.

Once the UE is activated, the UE may initiate a connection with an application system, which may be a platform used by telecommunications carriers and OEMs to manage and deliver applications to UEs to facilitate application pre-installation, targeting, and monetization. The UE may transmit a request to the application system for an application manifest detailing the applications that are to be pre-installed at the UE. The request may include metadata about the UE to ensure the manifest is tailored to the specification of the UE. The application system may return a manifest file with a list of predefined applications for pre-installation at the requesting UE, configurations for the applications, and download links (uniform resource locators (URLs)) for the applications.

The application system may initially define the list of predefined applications for UEs based on whether an application is part of a contract (e.g., a contract may indicate that a business enterprise is to pay $1 for each application pre-installed at a UE), based on an auction system (e.g., the UE may have slots for six pre-installed applications, and the highest bidding six applications may be selected as the six pre-installed applications at the UE), and/or based on whether an application is a carrier-specific application (e.g., a billing and account management application associated with the telecommunications carrier). That is, the predefined list of applications indicated in a manifest may be generically defined for all devices, regardless of whether the application has any relevance to the user. Said another way, the applications indicated in the predefined list have no connection to the user of the UE, the UE itself, or the network connected to the UE.

Therefore, more often than not, many of the applications that are pre-installed at UEs may be wasteful of memory and processing resources at the UE. There may be a limited time window with users as well, resulting in a lost opportunity by providing less optimal results within that window. Since the pre-installed applications may hardly be opened by the user, let alone engaged with, the process of the UE communicating with the application system to retrieve a manifest may be wasteful of network resources. Particularly, when these unused applications are pre-installed during OOBE for hundreds of thousands of UEs, the waste of network resources in communications with the application system and the waste of resources across the UEs amplifies significantly. Therefore, the considerations and methods for pre-installing applications at UEs during the initial powering on and setup phase is largely wasteful and inefficient from a resource and memory perspective, and ineffective in providing relevant content to users.

The present disclosure addresses the foregoing technical problems by providing a technical solution in the technical field of data processing systems and device initiation/setup. In various embodiments, the application system may include a pre-installation application that may use a machine learning model (referred to herein as data model application) provisioned at a data processing system to predict the optimal applications to pre-install at a UE of a user, and generate a custom manifest detailing the optimal applications. An optimal application may refer to an application that a user is likely to engage with at or above a predefined threshold frequency within a specific period. The prediction of the optimal applications reflect that the user is likely to consistently and habitually interact with the applications, given the history of the behavior of the user with respect to other applications. The UE may install the applications automatically using the links indicated in the custom manifest during the initial UE setup experience. In this way, the pre-installed applications at a UE are not based solely on the highest bidders and contracts, but may instead be based on the applications that are most likely to be of interest to the user. The embodiments disclosed herein thus reduce processing time and bandwidth usage by delivering more optimized applications to users for better long-term results.

In an embodiment, a communication system may include one or more UEs that are being powered on and setup with the telecommunications carrier, the application system, a data processing system, one or more data stores storing user data and/or billing data relevant to users, and a data store storing data used to dynamically pre-install applications at one or more UEs. The application system, as mentioned above, may be responsible for receiving requests from UEs for data regarding applications to pre-install at the UEs, and the application system may include a pre-installation application that uses the machine learning models at a data processing system and data stored at the data stores to identify/categorize users and determine the optimal applications for pre-installation at the UEs.

The data processing system may include a collection of one or more servers or computer systems, which may operate to run an AI-based data model application (e.g., using one or more types of AI-models, such as, a machine learning model, large language model, deep learning model, neural networking model, etc.). The data model application may be programmed to identify users (or user segments) of a requesting UE, and determine the optimal application for pre-installation at the UE based on various types of data, as further described herein. The data model application may be trained to make these identifications and determinations using training data.

The training data may include labelled or un-labelled datasets including diagnostic data, network data, billing data, and user data for various different users across a number of different UEs. In an embodiment, the diagnostic data may describe attributes of the UE (e.g., a device identifier/model/type/price, the international mobile equipment identity (IMEI) number, a device manufacturer, hardware/software specifications of the UE, etc.) and/or identify a carrier linked to the UE. The network data may include a location of the UE or a location/identification of a cell site/radio access network (RAN) connected to the UE, a type of network connection (e.g., WiFi or data connection), data describing a WiFi connection if applicable, a region/state/country/territory, etc. The billing data may include user account data associated with the UE, such as, for example, demographics data, residential/service/billing address, subscription plan data, usage data, etc. The user data may include application history data describing, for example, a history of applications installed at a UE of a user, the interactions and activities performed by the user with respect to the applications, and/or metatags describing user interactions and related content at the applications. The user data and billing data may be obtained from different databases owned by different enterprises in the communication system.

The training data may also include segment data describer user segments, or distinct groups of users/customers/subscribers of the telecommunications carrier based on shared characteristics, behaviors, location, or needs. User segments may be defined based on various criteria, such as, for example, demographics, usage patterns, device preferences, or geographic locations. Examples of user segments may be based on age groups (e.g., young adults 18-25 years old, middle aged customers, or seniors), income level (e.g., high income versus budget-conscious), occupation, family composition, content preferences, usage-based, geographic segments (e.g., urban versus rural), service plan segments (e.g., prepaid versus postpaid), etc.

The training data may include numerous (thousands, hundreds of thousands, millions, etc.) correlations between the diagnostic data, network data, billing data, user data, and segment data, such that the data processing system may use machine learning, deep learning, neural networking, and/or other AI-based algorithms to identify patterns and trends between different variations of the data and corresponding high-user interaction applications, to determine optimal applications to pre-install at a UE. The training data may also be based on historical data associated with prior combinations of diagnostic data, network data, billing data, user data, and segment data, indicating which pre-installed applications were the most engaged with by a user and which were the least engaged with by a user.

The data model application may communicate with (or include) an identification application, a pre-loading application, and a selection application. The aforementioned training data may be used to train the data model application, the identification application, pre-loading application, and/or the selection application to make the predictions disclosed herein. For example, the diagnostic data, network data, billing data, and segment data may be used to train the identification application to accurately identify an actual user of the UE (based on the user being an existing subscriber/customer) or identify a user segment of the UE (based on similar diagnostic data and network data received from the UE). The identification application may be trained to associate the UE and/or user with a user identifier at a data store based on whether the actual user is identified (e.g., the user identifier may be associated with an existing identifier of the user) or the user segment is identified (e.g., the user identifier may be associated with the identified user segment).

The diagnostic data, network data, billing data, and user data may be used in conjunction with an application library (describing all of the different applications available for pre-installation at a UE) to train the pre-loading application to determine the optimal applications to pre-install at the UE. For example, the pre-loading application may be trained with knowledge (e.g., as weights and parameters in the model algorithm) about the applications that users (with similar diagnostic data, network data, billing data, and user data) have interacted with the most at different UEs. Based on the training, the pre-loading application may be trained to determine applications that the user is most likely to interact and engage with using current data (diagnostic data, network data, billing data, and user data) received with regard to the user.

In some cases, the pre-loading application may also be trained based on request parameters, which may indicate targets or conditions for application selection (e.g., a target monetary value to achieve based on bids/contracts with enterprise systems providing the application). To this end, the pre-loading application may use the target monetary value to determine the optimal applications to pre-install at the UE based on monetary bids received from multiple different enterprise systems for different applications.

Post-setup engagement data describing interactions and engagements between the user and different applications installed at the UE over a predefined period of time after setup of the UE may be used to train the selection application to determine additional applications to recommend to the user for potential installation at the UE. The selection application may be trained to determine the additional applications, generate an updated manifest describing the additional applications, and transmit the updated manifest to the UE.

In this way the data model application, identification application, pre-loading application, and selection application may be trained to identify users/user segments, determine optimal applications to pre-install at UEs, and recommend additional applications to install at the UE. Using the aforementioned applications, the pre-installation application at the application system may receive a request from a UE that has been powered on for the first time for activation and connection to the telecommunications carrier. The request may include diagnostic data describing the UE and network data describing network connections to the UE. The pre-installation application may also receive request parameters from an operator of the system, and the request parameters may indicate conditions or targets for selecting the optimal applications for pre-installation at the UE. The pre-installation application may pass the received diagnostic data, network data, and/or request parameters to the data processing system for input into the data model application.

The data model application may first use the trained identification application to identify the user or user segment of the user associated with the UE based on the received diagnostic data and the network data. The data model application may then associate the UE and the received diagnostic data, network data, and request parameters with a user identifier of the user and/or associated with the user segment.

The data model application may then use the pre-loading application to identify an optimal quantity of applications to pre-install at the UE (e.g., based on the targets or conditions indicated in the request parameters). In an embodiment, the pre-installation application at the application system may transmit a message with information about the quantity of applications to the UE first, to allow the UE to allocate space in the memory and user interface for the additional quantity of applications.

The data model application may then use the pre-loading application to obtain relevant billing data and user data associated with the user and/or UE (e.g., from the databases), store the billing data and user data with the user identifier, and then determine the applications to pre-install at the UE based on the diagnostic data, network data, billing data, and user data. In some cases, this selection of optimal applications may be based on the applications that are predicted to be the most likely to be useful to the user and engaged with by the user frequently based on the training data. In some cases, the selection of optimal applications may be additionally based on monetary bids for applications provided by respective enterprise systems. The data model application may then use the pre-loading application to generate a custom manifest describing the applications and including a link to and instructions for installing the applications, and the custom manifest may be sent directly to the UE. The UE may use the links/resources indicated in the custom manifest to automatically download the applications indicated in the custom manifest during the setup time of the UE (e.g., during the 2-3 minutes OOBE experience).

The data model application may then use the selection application to identify additional applications to recommend for installation at the UE based on the post-setup engagement data, using the application library accessible to the data processing system. For example, when the post-setup engagement data indicates that the user is most actively engaging with fashion retail applications, the additional applications may include one or more similar fashion retail applications, that may or may not be relevant to the identified user segment (e.g., age group). The data model application may then use the selection application to generate an updated manifest describing the additional applications, and the updated manifest may be transmitted to the UE. The UE may receive the updated manifest, and instead of automatically downloading the applications, the UE may generate a present a notification on a display of the UE indicating the additional applications as recommended particularly for the user. The notification may include selectable icons allowing the user to accept the recommendation and install the application, or reject the recommendation entirely and notify the data processing system (as feedback data).

In this way, the application system may use a data processing system running various applications and AI-based models to more efficiently and effectively determine applications to pre-install at UEs, all during the 2-4 minutes OOBE expected time period. Unlike the OOBE manifest system in which core applications are embedded directly into the device firmware or as application packages, the embodiments disclosed herein tailor the pre-installed applications to the user efficiently using the data processing system, without significant changes to device firmware or device protocols. Moreover, since the pre-installed applications determined based on the methods disclosed herein are far more likely to be opened and interacted with by users of the UEs, the pre-installed applications are not wasteful of memory resources and the transmission of the custom/updated manifest is far more efficient in terms of network resource utilization. By reducing the number of unused applications across UEs, the embodiments disclosed herein increase the capacity at the UEs and in the network (e.g., both processing and communication resources).

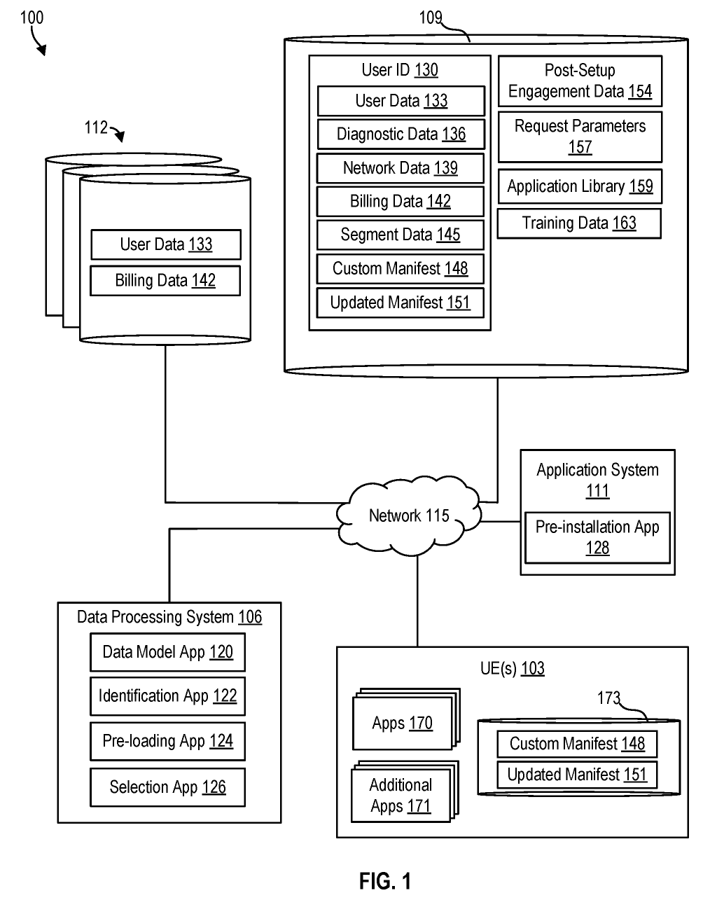

Turning now to FIG. 1, a communication system 100 is described. The communication system 100 includes a UE 103, a data processing system 106, a data store 109, an application system 111, one or more databases 112, and a network 115. The network 115 may be one or more private networks, one or more public networks, or a combination thereof. While the data processing system 106, data store 109, application system 111, and databases 112 are shown as separate from the network 115 in FIG. 1, it should be appreciated that the data processing system 106, data store 109, application system 111, and databases 112 may be included as part of the network 115 in various embodiments. While the data store 109 and databases 112 are shown as separate from the data processing system 106 and/or application system 111, in some embodiments, the data processing system 106 and/or application system 111 may include one or more of the data stores 109 and/or the databases 112.

The UEs 103 may refer to a device that, when powered on for the first time, is capable of being connected to a network (e.g., via a cell site of the attached carrier network or via a WiFi connection), and is capable of pre-installing applications 170 during the initial setup (OOBE) of the device. For example, the UE 103 may be a cell phone, tablet, or smart wearable device. The UE 103 may include a display and a user interface (UI) through which a user of the UE 103 may interact with the applications 170.

The pre-installed applications 170, in the context of the OOBE, refer to applications that are dynamically installed onto the UE 103 during the initial setup of the UE 103, rather than being embedded in the firmware of the UE 103 or installed manually by selection of the user in an application store of the UE 103. The pre-installed applications 170 may include, for example, first-party applications (from the manufacturer or carrier) and third-party applications, which as further described herein, may be selected based on user demographics, region, or business agreements. Examples of the pre-installed applications 170 may include gaming applications, shopping applications, streaming media applications, reading applications, and news applications.

The UE 103 may also include a data store 173 (e.g., one or more memories) to store the custom manifest 148 and the updated manifest 151 upon receipt from the application system 111. As described herein, the custom manifest 148 is generated by the application system 111 using the data processing system 106 and is a file that provides instructions for dynamically installing optimally selected applications 170 for pre-installation at the UE 103. The custom manifest 148 may include details such as application package names, installation links (URLs), installation rules, and metadata (e.g., regional settings, carrier preferences, or advertisement tracking identifiers) of the identified applications 170. The UE 103 may receive the custom manifest 148 during the initial setup (e.g., OOBE) and use the custom manifest 148 to download, install, and configure the indicated applications 170.

The updated manifest 151 may be similarly generated by the application system 111 using the data processing system 106 and is a file that provides instructions for dynamically installing additional (recommended) applications 171 at the UE 103. The updated manifest 151 may include details such as application package names, installation links (URLs), installation rules, and metadata (e.g., regional settings, carrier preferences, or advertisement tracking identifiers) of the additional applications 171. The additional applications 171 are not for pre-installation, but are rather determined a period of time after the initial setup of the UE 103, and is based on the user engagement at the UE 103 during the period of time. The UE 103 may receive the updated manifest 151 after the period of time and use the updated manifest 151 to display a notification listing the additional applications 171 with selectable user interface elements at the UE 103, allowing the user to select whether to accept each recommended additional application 171 (and thus download, install, and configure the indicated applications 171) or reject each recommended additional application 171. An indication of whether the user accepted or rejected each recommended additional application 171 may be transmitted back to the data processing system 106 as feedback data, to update the algorithms, weights, and parameters of the underlying machine learning operating with the additional applications 171 of the data processing system 106.

The data processing system 106 may be system (e.g., a set of servers including a collection of memory, processing, and communication resources) responsible for receiving requests for UEs 103 and parameters from operators of the system from the application system 111, obtaining additional data based on the requests, and evaluating the data to identify the users and determine applications 170 to pre-install at UEs 103, as further described herein. The data processing system 106 may include a data model application 120, an identification application 122, a pre-loading application 124, and a selection application 126. The data model application 120 may be trained to use the identification application 122, pre-loading application 124, and selection application 126 to evaluate data, identify a user/user segment of the UE 103, and determine the optimal applications 170 to pre-install at the UE 103.

For example, the data model application 120 may be trained to use the identification application 122 to evaluate data received from the UE 103 (e.g., diagnostic data 136 and network data 139), obtain billing data 142 if applicable, and identify a user or a user segment based on the evaluation of the data (using the trained machine learning algorithms accessible at the data processing system 106).

The data model application 120 may be trained to use the pre-loading application 124 to obtain user data 133 relevant to the identified user or user segment, evaluate the user data 133, diagnostic data 136, network data 139, and billing data to select one or more applications 170 to pre-install at the requesting UE 103 (using the trained machine learning algorithms accessible at the data processing system 106). An optimally selected application 170 may be one with a likelihood (e.g., value) of being interacted with or engaged by the user of the UE 103, in some cases, above a predefined threshold. The data model application may be trained to use the selection application 126 to evaluate post-setup engagement data 154 of the UE 103 to identify the additional applications 171 to recommend to the user for installation at the UE 103 (a predefined period of time after the initial setup of the UE 103) (using the trained machine learning algorithms accessible at the data processing system 106).

The data model application 120, identification application 122, pre-loading application 124, and selection application 126 may be trained to run using one or more AI-based models, or predictive models, as mentioned above. A predictive model (also referred to herein as “data model”) may refer to a machine learning model (e.g., neural networking model, deep learning model, natural language processing model, etc.) that leverages algorithms and statistical techniques to analyze input features of and identify patterns to score words in prompts, determine intent parameter sets of prompts, extract keywords from prompts, and generate database queries to retrieve the information requested in the prompts. The data model may be implemented using software (e.g., algorithms, logic, and code) stored across one or more memories, and the underlying hardware of the data processing system 106 may provide the computational resources for execution of the data model. The data model may be implemented as one or more different types of models using, for example, linear regression, decision trees, support vector machines, neural networks, or ensemble methods. It should be appreciated that any type of data model may be used, and the underlying algorithms, computations, and machine learning libraries used by the data model should not be limited herein. As described herein, the data model may be trained using data stored at the databases 112 and data stored at the data store 109.

The application system 111 may be a collection of servers (e.g., with hardware and software resources) implementing a platform for managing the pre-installation of applications 170 across a number of UEs 103. The application system 111 may be used by telecommunications carriers and OEMs to manage and deliver applications 170, 171 to UEs 103 to facilitate application pre-installation, post-setup application installation, targeting, and monetization. The application system 111 includes a pre-installation application 128 that operates with the data model application 120, identification application 122, pre-loading application 124, and selection application 126 of the data processing system 106. For example, the pre-installation application 128 may receive a request including diagnostic data 136 and network data 139 from the UE 103, receive user data 133 and billing data 142 from the databases 112, transmit the diagnostic data 136, network data 139, user data 133, and billing data 142 to the data processing system 106 for processing, receive the list of optimally selected applications 170 for pre-installation at the UE 103 and the list of additional applications 171 for subsequent installation at the UE 103 from the data processing system, and generate the custom manifest 148 and updated manifest 161 based on the lists received from the data processing system 106.

The data store 109 may be a collection of one or more memories (co-located or distributed across different data centers), which are accessible by the data processing system 106 and the application system 111. As shown in FIG. 1, the data store 109 may store a user identifier 130 and different types of data in association with the user identifier 130. The data stored in association with the user identifier 130 may include user data 133, diagnostic data 136, network data 139, billing data 142, segment data 145, one or more custom manifests 148, and one or more updated manifests 151. The data store 109 may also store post-setup engagement data 154, request parameters 157, an application library 159, and training data 163.

The user identifier 130 may be a unique identifier or value identifying a user or a user segment. For example, the user identifier 130 may identify a unique user when the user is a known, existing subscriber of the telecommunications carrier. The user identifier 130 may identify a user associated with a specific user segment when the user is unknown (i.e., the user may not be an existing subscriber of the telecommunications carrier).

The user data 133 refers to data indicative of behavioral and interactional patterns of users as they engage with various applications across UEs 103 over time. The user data may describe data, media, or interactive elements (e.g., videos, articles, products, posts, or in-app features) that a user or user segment has engaged with (e.g., viewed, clicked, or otherwise interacted with) across different applications, as recorded by engagement metrics, such as time spent, actions taken, or frequency of interaction with each application.

The user data 133 may include an application history (e.g., applications a user installs, deletes, or never uses), login behaviors, and preferences for specific types of content or digital experiences (e.g., advertisements). The user data 133 may also capture responses to targeted promotional stimuli (e.g., campaigns or engagement triggers) and metadata linked to ad-tech systems, including identifiers, metatags, and/or cookies. Collectively, the user data 133 for a particular user or a group of users with similar attributes (i.e., a user segment) provides a comprehensive view of user activity, preferences, habits, and responsiveness across digital ecosystems.

The diagnostic data 136 may be received from the UE 103 and may describe attributes of the UE 103 (e.g., a model of the UE 103, a type of the UE 103, retail price of UE 103, the international mobile equipment identity (IMEI) number, a manufacturer, hardware/software specifications of the UE 103, location of the UE 103, etc.) and/or identify a carrier linked to the UE 103. The network data 139 may be received from a UE 103 or from a core network of the carrier network to which the UE 103 is attached. For example, the network data 139 may include a location of the UE 103 or a location of a cell site/RAN connected to the UE 103, a type of network connection (e.g., WiFi or data connection), data describing a WiFi connection if applicable, a region/state/country/territory, telemetry qualities of the network connection with the UE 103, etc. The billing data 142 may be received from a billing system at a core network of the carrier network to which the UE 103 is attached. For example, the billing data 142 may include user account data associated with the UE 103, such as, for example, demographics data, residential/service/billing address, subscription plan data, usage data, etc.

The segment data 145 may define distinct user segments, or groups of users categorized based on shared attributes, behaviors, or preferences of each of the users (as may be collected based on the user data 133). The segment data 145 may include characteristics, interactions, and patterns associated with each user segment, such as demographics, usage habits, device preferences, or responsiveness to specific content or campaigns. The segment data 145 may also be linked to user identifiers 130 of the known users that are members of the user segment. For example, the segment data 145 for a first user segment may indicate the shared attributes, behaviors, or preferences of the users, and may include the user identifiers 130 of all the users in the first user segment. The segment data 145 may also include a designated group of unassigned user identifiers 130, or may indicate a prefix or suffix that may be part of all user identifiers 130 assigned to users of the user segment.

For example, when a user powering on a UE 103 is unknown, the identification application 122 may associate the diagnostic data 136 and the network data 139 with billing data 142 if available, and then determine a user segment that matches the combination of the diagnostic data 136, network data 139, and/or billing data 142. The identification application 122 may then assign a user identifier 130 the UE 103 from the designated group of unassigned user identifiers 130 associated with the user segment, or assign the UE 103 a user identifier 130 with the prefix or suffix assigned to the user segment.

The custom manifest 148 is generated by the application system 111 using the data processing system 106 and is a file that provides instructions for dynamically installing optimally selected applications 170 for pre-installation at the UE 103. The custom manifest 148 describes the applications 170 to pre-install and includes links and instructions to install the applications 170 at the UE 103. The updated manifest 151 is similarly generated by the application system 111 using the data processing system 106 and is a file that provides instructions for dynamically installing additional (recommended) applications 171 at the UE 103. The updated manifest 151 describes additional applications 171 and includes links and instructions to install the additional applications 171 at the UE 103.

The post-setup engagement data 154 may include data describing interactions and engagements between the user and different applications installed at the UE 103 over a predefined period of time after setup of the UE 103. The post-setup engagement data 154 may be used to train the selection application 126 to determine additional applications 171 to recommend to the user for potential installation at the UE 103.

The request parameters 157 may be received from an operator of the application system 111. The request parameters 157 may include conditions or targets considered by the pre-installation application 128, data model application 120, and pre-loading application 124 to identify the optimal applications 170 to pre-install at the UE 103. For example, the request parameter 157 may include a target monetary value for the set of pre-installed applications 170 at a UE 103. In this case, the pre-installation application 128 may instruct the data model application 120 and the pre-loading application 124 to select the applications 170 to pre-install application 170 at the UE 103 based not only on the evaluation of the data stored with the user identifier 130 to determine the applications 170 that are most likely to be engaged with by the user, but also based on the highest bids received for the applications 170 from enterprise systems providing the applications 170. The request parameter 157 may in some cases include conditions regarding the applications (e.g., certain types of applications 170 may be prohibited from being pre-installed at certain types/models/makes of the UE 103, only certain types of applications 170 are permitted to be pre-installed at certain types/models/makes of the UE 103).

The application library 159 may be a repository of software applications available for installation at the UE 103. The application library 159 may include metadata about each application, including instructions and links for installation, installation and deletion history, versioning, usage frequency, and engagement patterns across a number of different users. The application library 159 may also include information about permissions granted, updates applied, and inter-application interactions/dependencies.

The training data 163 may include labelled or un-labelled datasets including diagnostic data 136, network data 139, billing data 142, and user data 133 collected for various different users across a number of different UEs over a period of time, historically. The training data may include labelled datasets including historical data describing associations between users and content that the users have engaged with across different applications. The training data 163 may indicate numerous (tens, hundreds, thousands, etc.) correlations between the diagnostic data 136, network data 139, billing data 142, user data 133, and segment data 145, such that the data processing system 106 may use machine learning, deep learning, neural networking, and/or other AI-based models to determine patterns and trends between different variations of the data and corresponding high-interaction applications, to determine optimal applications 170 to pre-install at a UE.

The databases 112 may refer to an organized collection of data that stores one or more types of data that may be accessed by the pre-installation application 128 (and/or the data processing system 106). The databases 112 may be managed by different enterprise systems or by a core network of a telecommunications carrier with which a user may be a subscriber. For example, the user data 133 may be stored across multiple databases 112, each being associated with a different application, website, or other content accessed or engaged with by the user. The billing data 142 may be stored at a database 112 of a billing system, in a core network of a telecommunications carrier with which the user may be a subscriber.

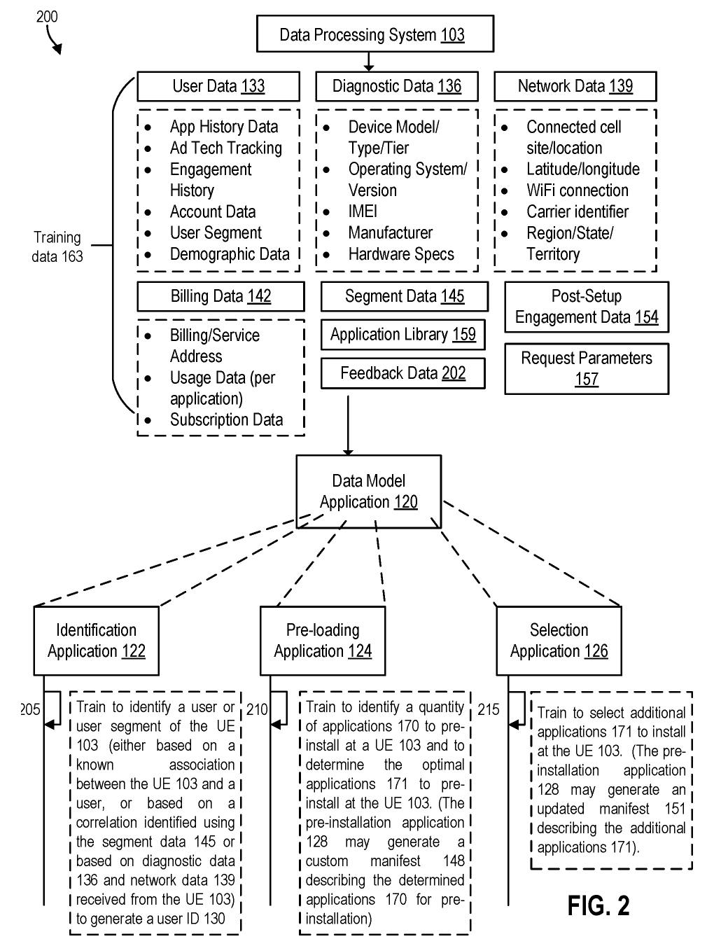

Referring now to FIG. 2, shown is a diagram 200 illustrating the training of the data model application 120, identification application 122, pre-loading application 124, and selection application 126 according to various embodiments of the disclosure. As described above and shown in FIG. 2, the data model application 120 uses the identification application 122, pre-loading application 124, and selection application 126 during training and evaluation of data.

The data processing system 106 may obtain training data 163 and other types of training data to train the data model application 120, identification application 122, pre-loading application 124, and selection application 126. The training data 163 includes predefined, labelled batches of user data 133, diagnostic data 136, network data 139, billing data 142, segment data 145, post-setup engagement data 154, and request parameters 157, which the data model application 120, identification application 122, pre-loading application 124, and selection application 126 may use with the application library 159 to (1) recognize patterns and trends between different combinations of diagnostic data 136, network data 139, and/or billing data 142 and different user segments (as indicated in the segment data 145), and (2) recognize patterns and trends between different types of applications available in the application library 159 and users with a common pattern of user data 133, diagnostic data 136, network data 139, and/or billing data 142.

For example, the user data 133 may include historical data including, for different users, an application history data, ad-tech tracking data, engagement histories, account data, user segment data, demographic data, etc. For example, the diagnostic data 136 may include a device model, type, or tier, an operation system or version, an IMEI, a manufacturer, hardware specifications, etc. For example, the network data 139 may include data describing a connected cell site/location, latitude and longitude coordinates, data describing a WiFi connection if applicable, a carrier identifier of a telecommunications associated with the UE 103, a region/state/territory, etc. For example, the billing data 142 may include addresses, usage data (per application, used for billing), subscription data (e.g., subscription plan details), etc. Once the patterns and trends have been quantified into the algorithms, parameters, and weights provisioned at the data processing system 106, the data model application 120, identification application 122, pre-loading application 124, and selection application 126 may be trained based on the training data 163.

The training data 163 may also include feedback data 202 received from the UEs 103 indicating, for example, whether a pre-installed application 170 was indeed accurately predicted as being of interest to the user (e.g., based on whether the application 170 was opened, interacted with, or engaged with above a threshold quantity of times, which may be indicated in the post-setup engagement data 154). The feedback data 202 may alternatively indicate whether a pre-installed application 170 was not accurately predicted as being of interest to the user (e.g., based on whether the application 170 was not opened, not interacted with, or not engaged with above a threshold quantity of times, which may be indicated in the post-setup engagement data 154). The feedback data 202 may also indicate whether the recommended, additional applications 171 were accepted and installed at the UE 103 or rejected and not installed at the UE 103.

During training, the data model application 120 may direct the training of one or more of the identification application 122, pre-loading application 124, and selection application 126 based on the training data 163 in view of the available applications indicated in the application library 159 (and history of applications used by the user/user segment). As shown in FIG. 2, the data model application 120 may perform operation 205 to train the identification application 122 to identify a user or user segment of the UE 103. In an embodiment, this identification may be based on a known association between the UE 103 and the user (e.g., the user is already a subscriber of the telecommunications carrier, the UE 103 is an upgraded device, and data regarding the user is stored at a database 112 (e.g., at a core network) associated with the telecommunications carrier). In this embodiment, the identification application 122 may be trained to generate a unique user identifier 130 for the UE 103 (and this may in some cases, be obtained from or based on an identification stored at the database 112 of the telecommunications carrier).

In another embodiment, (e.g., when the user is not a current subscriber of the telecommunications carrier) this identification may be based on diagnostic data 136 and network data 139 received from a UE 103, which may be cross-correlated with billing data 142 if available (e.g., the IMEI in the diagnostic data 136 can be linked to a newly activated user account in the billing data). This combination of the data may be used as attributes that may be matched to a user segment indicated in the segment data 145.

For example, the diagnostic data 136 may indicate a type of UE 103 (e.g., a high-end, expensive UE 103), and the network data 139 may indicate that user is in a location of high-end retail stores. In this case, the training of the identification application 122 may correlate the pattern identified between the diagnostic data 136 and network data 139 (e.g., the pattern being that the user owns an expensive UE 103 and shops at expensive retail stores, which can be used to predict that the user of the UE 103 is of a high-income class). In this example, the identification application 122 may associate the user of the UE 103 with a high-income user segment based on the segment data 145. In this embodiment, the identification application 122 may be trained to associate the user of the UE 103 with a user identifier 130 associated with the identified high-income user segment. The user identifier 130 may be one of the unassigned user identifiers 130 associated with the particular user segment, or include a prefix/suffix specifically identifying the user as being associated with the user segment.

The data model application 120 may perform operation 210 to train the pre-loading application 124 to recognize patterns and trends between applications and users that are associated with similar user data 133, diagnostic data 136, network data 139, and billing data 142 (historical data, which may be labelled or un-labelled), and thus determine an optimal set of applications 170 for pre-installation at a UE 103. First, the pre-loading application 124 may be trained to identify a quantity of applications 170 to pre-install based on existing contracts that may affect the number of applications 170 that may be installed at the UE 103 and/or based on request parameters 157 indicating conditions or targets related to the pre-installation of the applications 170. The pre-loading application 124 may then be trained to determine the optimal applications 170 to pre-install at a UE 103. For example, an optimal application 170 may be an application, determined by the pre-loading application 124, that has a likelihood (e.g., value) of being interacted with or engaged by the user of the UE 103 at least a predefined threshold quantity of times over a predefined period of time after installation during setup. The predefined threshold quantity of times and the predefined period of time may be determined by the pre-loading application 124 based on the historical data indicated in the training data 163, using the trained algorithms, weights, and parameters defined in the data model of the data processing system 106. The pre-installation application 170 may generate the custom manifest 148 based on the list of optimal applications 170 received from the pre-loading application 124.

The data model application 120 may perform operation 215 to train the selection application 126 to select additional applications 171 to recommend for installation at the UE 103 (a predefined period of time after the initial setup of the UE 103 is complete). The selection application 126 may be trained to determine the additional applications 171 based on the post-setup engagement data 154 using the application library 159). The pre-installation application 170 may generate the updated manifest 151 based on the list of additional applications 171 received from the selection application 126. Once the data model application 120, identification application 122, pre-loading application 124, and selection application 126 are trained, the data model application 120, identification application 122, pre-loading application 124, and selection application 126 may be used to evaluate incoming requests for the custom manifest 148 more accurately and efficiently.

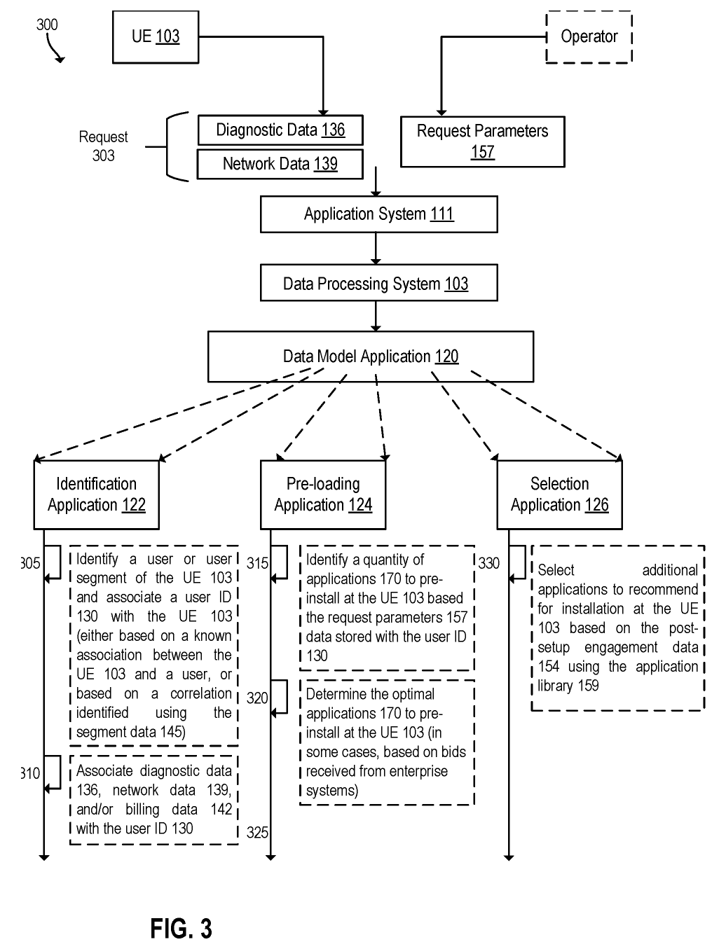

Referring now to FIG. 3, shown is diagram 300 illustrating the use of the trained data model application 120, identification application 122, pre-loading application 124, and selection application 126 in the data processing system 106 to identify users and determine the optimal applications 170 to pre-install at UEs 103 according to various embodiments of the disclosure. In this embodiment, the data model application 120, identification application 122, pre-loading application 124, and selection application 126 have been trained according to operations described in FIG. 2 using the training data 163. As shown in FIG. 3, a UE 103 may transmit a request 303 to the application system 111 after having been powered on for the first time and initiating setup of the UE 103 (i.e., the OOBE). The request 303 may include diagnostic data 136 describing the UE 103 and network data 139 describing network connections of the UE 103 (and attributes of the network connections). Prior to receiving the request (or simultaneously) an operator may provide request parameters 157 to the application system 111, in which the request parameters 157 may include conditions or targets relevant to the pre-installation of applications 170 at the UE 103.

The pre-installation application 128 at the application system 111 may package the diagnostic data 136, network data 139, and/or request parameters 157 for transmission to the data processing system 106. The data model application 120 may obtain the diagnostic data 136, network data 139, and/or request parameters 157, and the pre-installation application 128 may communicate with the data model application 120 to make predictions using the identification application 122, pre-loading application 124, and selection application 126.

In an embodiment, the pre-installation application 128 at the application system 111 may instruct the data model application 120 to use the received diagnostic data 136 and network data 139 to obtain billing data 142 that may correspond to the diagnostic data 136. For example, the diagnostic data 136 may indicate an IMEI, and a database 112 may store billing data 142 associating the IMEI with a line of a particular subscriber/user. In other cases, the diagnostic data 136 may not include information directly linking the UE 103 to an existing subscriber/user, but the diagnostic data 136 (e.g., device type, price, etc.) may be used by the identification application 122 in conjunction with network data 139 (e.g., location of the UE 103) to identify a user segment.

At operation 305, the data model application 120 may use the identification application 122 to identify a user or user segment of the UE 103. For example, the identification application 122 may identify a user based on a known association between the UE 103 and a user (e.g., an existing subscriber). The known association may be based on billing data 142 indicating at least a portion of the diagnostic data 136 and/or network data 139. Alternatively, the identification application 122 may identify an unknown user as being part of a user segment based on patterns and trends identified in the diagnostic data 136 and network data 139 received from the UE 103, using the segment data 145 based on the training of the identification application 122.

At operation 310, the data model application 120 may use the identification application 122 to associate the received diagnostic data 136 and network data 139 with the retrieved billing data 142, and store the diagnostic data 136, network data 139, and billing data 142 with a user identifier 130 of the user. The user identifier 130 may be determined based on an identification of the identified, known user or based on an identification, prefix, or suffix associated with the identified user segment.

In an embodiment, the pre-installation application 128 at the application system 111 may instruct the data model application 120 to obtain user data 133 associated with the identified, known user and/or the identified user segment. For example, the user data 133 may include historical data indicative of application downloads, deletes, logins, purchases, interactions, and other engagement activity of the user/user segment for a number of different applications, and the user data 133 pertaining to each of the different applications may be received from different databases 112. For example, user data 133 associated with the use and engagement of the user/user segment for a first application may be received from a first database 112, while user data 133 associated with the use and engagement of the user/user segment for a second application may be received from a second database 112. The pre-installation application 128 may store the user data 133 with the diagnostic data 136, network data 139, and billing data 142 in association with the user identifier 130.

At operation 315, the data model application 120 may use the pre-loading application 124 to identify a quantity of applications 170 to pre-install at the UE 103 based on the request parameters 157 and the data stored in association with the user identifier 130 (e.g., the user data 133, diagnostic data 136, network data 139, and billing data 142). For example, the request parameters 157 may indicate a target monetary value to receive from enterprise systems providing the applications 170 for pre-installation, a list of applications 170 permitted to or prohibited from being pre-installed at the UE 103 or type of UE 103, a memory limit for applications 170 that may be pre-installed at the UE 103, etc.

At operation 320, the data model application 120 may use the pre-loading application 124 to determine the optimal applications 170 for pre-installation at the UE 103 based on the data stored in association with the user identifier 130 (e.g., the user data 133, diagnostic data 136, network data 139, and billing data 142), the request parameters 157, and the application library 159. In an embodiment in which the request parameters 157 indicate a target monetary value, the applications 170 may be determined based on the highest bidding applications 170 for the quantity of applications 170 determined in operation 315. For example, the pre-loading application 124 may first determine the applications 170 based on a likelihood that the application 170 will be heavily interacted with or engaged by the user of the UE 103 (e.g., the value of the likelihood may exceed a predefined threshold for a predefined period of time). In an embodiment, the pre-loading application 124 may contact enterprise systems providing the determined applications 170, indicating that the application 170 is likely to be engaged by the user, and offering the enterprise system an opportunity to bid for one of the slots in the identified quantity of applications 170 for pre-installation at the UE 103. The pre-loading application 124 may then select applications 170 having the highest bidding values as the quantity of applications 170.

In this way, the data model application 120 may use the pre-loading application 124 to determine the optimal quantity of applications 170 to pre-install at the UE 103 and ultimately the optimal applications 170 for pre-installation at the UE 103. The data model application 120 may transmit a list of the optimal applications 170 to the application system 111, and the pre-installation application 128 at the application system 111 may generate a custom manifest 148 describing the applications 170 and including links and instructions for installing the applications 170 at the UE 103. The pre-installation application 128 may transmit the custom manifest 148 to the UE 103.

In an embodiment, the pre-installation application 128 at the application system 111 may instruct the data model application 120 to obtain post-setup engagement data 154 associated with the UE 103. As described above, the post-setup engagement data 154 may describe all activities performed at the UE 103 with respect to any and all installed applications over a predefined period of time. For example, the post-setup engagement data 154 may indicate times and durations during which the user interacted with each application, the purchases made using the applications, the advertisements selected while using each application, the streaming content viewed or listened to in each application, etc.

At operation 330, the data model application 120 may use the selection application 126 to select additional applications 171 to recommend for installation at the UE 103 based on the post-setup engagement data 154 using the application library 159. For example, the selection application 126 may evaluate the post-setup engagement data 154 to determine that the user is a frequent purchaser of hats on fashion retail applications. In this case, the selection application 126 may determine the additional applications 171 as being additional, popular fashion retail applications 171 that offer hats for sale. The data model application 120 may transmit a list of the additional applications 171 to the application system 111, and the pre-installation application 128 at the application system 111 may generate an updated manifest 151 describing the additional applications 171 and including links and instructions for installing the additional applications 171 at the UE 103. The pre-installation application 128 may transmit the updated manifest 151 to the UE 103.

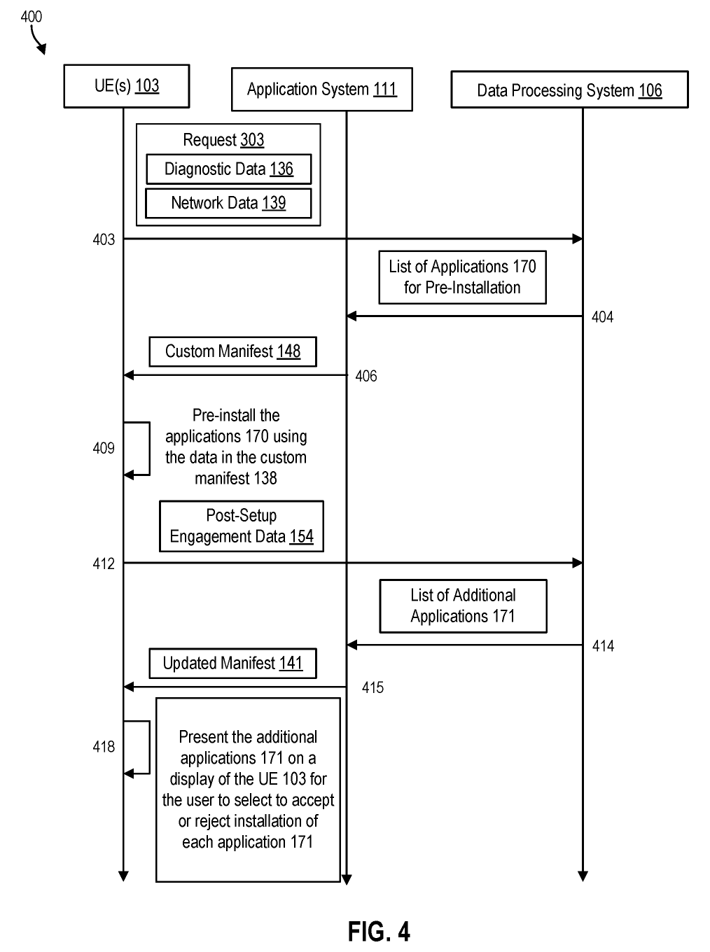

FIG. 4 is a message sequence diagram illustrating a method 400 for dynamically pre-installing applications 170 at a UE 103 according to various embodiments of the disclosure. Method 400 may be performed by the UE 103, application system 111, and data processing system 106.

At operation 403, UE 103 may transmit a request 303 comprising diagnostic data 136 and network data 139 to the data processing system 106. Using the methods described above, at operation 404, the data processing system 106 (namely the data model application 120 using the pre-loading application 124) may generate and transmit a list of (optimal) applications 170 for pre-installation at the UE 103 to the application system 111. The pre-installation application 128 at the application system 111 may generate a custom manifest 148 including data, links, and instructions to install each of the (optimal) applications 170 at the UE 103. At operation 406, the pre-installation application 128 at the application system 111 transmit the custom manifest 148 back to the UE 103. At operation 409, the UE 103 may pre-install the applications 170 using the data in the custom manifest 148.

At operation 412, the data processing system 106 may collect post-setup engagement data 154 from the UE 103. At operation 414, the data processing system 106 (namely the selection application 126) may generate and transmit a list of additional (recommended) applications 171 to the application system 111. The pre-installation application 128 at the application system 111 may generate an updated manifest 151 including data, links, and instructions to install each of the (optimal) additional applications 171 at the UE 103. At operation 415, the pre-installation application may transmit the updated manifest 151 back to the UE 103. At operation 418, the UE 103 may present the additional applications 171 as a notification on a display of the UE 103, with user interface elements for the user to select to accept or reject installation of each application 171.

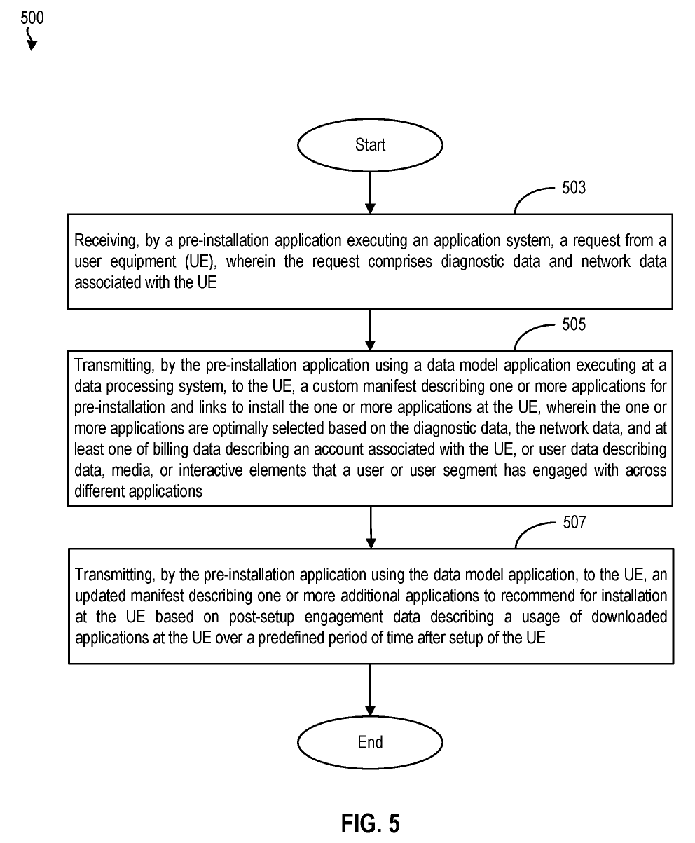

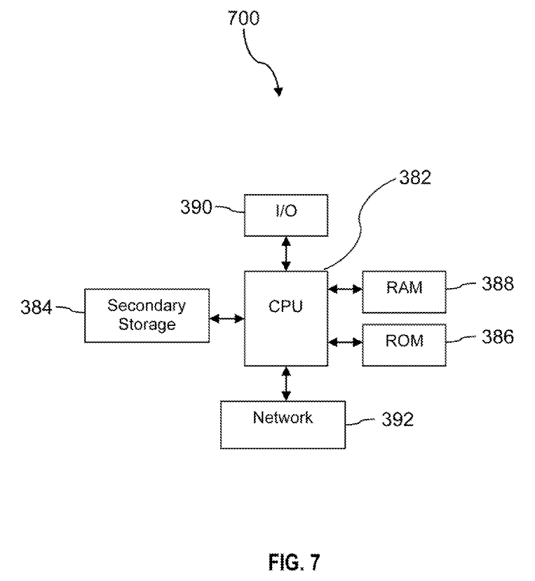

Referring now to FIG. 5, shown is a method 500 of dynamically pre-installing applications 170 in the communication system 100 of FIG. 1 according to various embodiments of the disclosure. In embodiments, the method 500 may be implemented using a computer system with components as shown in FIG. 7. As illustrated, method 500 of FIG. 5 includes a number of enumerated operations, but embodiments of the operations in FIG. 5 may include additional operations before, after, and in between the enumerated operations. In some embodiments, one or more of the enumerated operations may be omitted or performed in a different order.

At step 503, method 500 comprises receiving, by a pre-installation application 128 executing an application system 111, a request 303 from a UE 103. In an embodiment, the request 303 comprises diagnostic data 136 and network data 139 associated with the UE 103. At step 505, method 500 comprises transmitting, by the pre-installation application 128 using a data model application 120 executing at a data processing system 106, to the UE 103, a custom manifest 148 describing one or more applications 170 for pre-installation and links to install the one or more applications 170 at the UE 103. In an embodiment, the one or more applications 170 are optimally selected based on the diagnostic data 136, the network data 139, billing data 142 describing an account associated with the UE 103, and user data 133 describing an application history of the user. At step 507, method 500 comprises transmitting, by the pre-installation application 128 using the data model application 120, to the UE 103, an updated manifest 151 describing one or more additional applications 171 to recommend for installation at the UE 103 based on post-setup engagement data 154 describing a usage of downloaded applications at the UE 103 over a predefined period of time after setup of the UE 103.

Method 500 may include other steps and/or features that are not otherwise shown in FIG. 5. In an embodiment, method 500 may further comprise training the data model application 120 using training data 163, in which the training data 163 comprises datasets including historical data describing one or more UEs, users of the one or more UEs, network connections of the one or more UEs, and applications installed at the one or more UEs. In an embodiment, the diagnostic data 136 describes at least one of attributes of the UE 103 or carrier metadata describing a telecommunications carrier linked to the UE 103, and wherein network data 139 describes a location of the UE 103 and a type of network connected to the UE 103.

In an embodiment, method 500 may further comprise retrieving, by the pre-installation application 128, from one or more databases 112 in the communication system 100, the user data 133 including the application history describing a history of applications downloaded by the user, data tracking the user activity of the user across different applications, and metatags describing user interactions and related content. In an embodiment, when the UE 103 is associated with a user that is an existing subscriber of a telecommunications carrier system, method 500 may further comprise determining, by the data model application 120, a user identifier 130 of the user based on billing data 142 associated with the UE 103 and indicating a user account of the user. In an embodiment, when the user of the UE is unknown to a telecommunications carrier system, method 500 may further comprise determining, by the data model application 120, a user segment of the user based the diagnostic data 136 and billing data 142 associated with the UE 103, and associating, by the pre-installation application 128, the user with a user identifier 130 based on the user segment. In an embodiment, the diagnostic data 136 comprises a device identifier of the UE 103, and wherein the network data 139 comprises an identifier of a network or cell site connected to the UE 103.

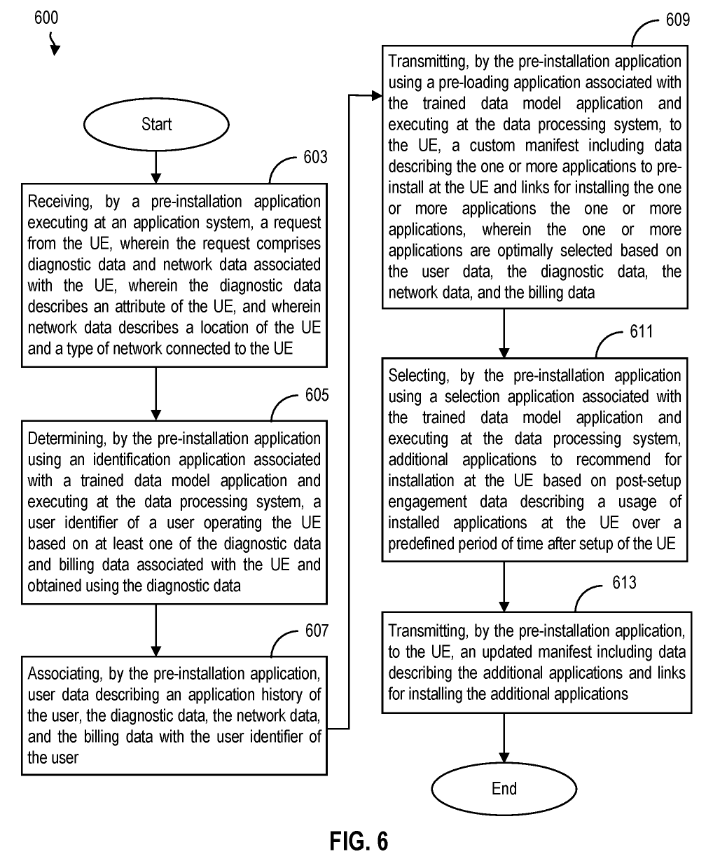

Referring now to FIG. 6, shown is a method 600 of dynamically pre-installing applications 170 in the communication system 100 of FIG. 1 according to various embodiments of the disclosure. In embodiments, the method 600 may be implemented using a computer system with components as shown in FIG. 7. As illustrated, method 600 of FIG. 6 includes a number of enumerated operations, but embodiments of the operations in FIG. 6 may include additional operations before, after, and in between the enumerated operations. In some embodiments, one or more of the enumerated operations may be omitted or performed in a different order.

At step 603, method 600 comprises receiving, by a pre-installation application 128 executing at an application system 111, a request 303 from the UE 103. The request 303 comprises diagnostic data 136 and network data 139 associated with the UE 103, the diagnostic data 136 describes an attribute of the UE 103, and network data 139 describes a location of the UE 103 and a type of network connected to the UE 103. At step 605, method 600 comprises determining, by the pre-installation application 128 using an identification application 122 associated with a trained data model application 120 and executing at the data processing system 106, a user identifier 130 of a user operating the UE 103 based on at least one of the diagnostic data 136 and billing data 142 associated with the UE and obtained using the diagnostic data 136. At step 607, method 600 comprises associating, by the pre-installation application 128, user data 133 describing an application history of the user, the diagnostic data 136, the network data 139, and the billing data 142 with the user identifier 130 of the user.

At step 609, method 600 comprises transmitting, by the pre-installation application 128 using a pre-loading application 124 associated with the trained data model application 120 and executing at the data processing system 106, to the UE 103, a custom manifest 148 including data describing the one or more applications 170 to pre-install at the UE 103 and links for installing the one or more applications 170. The one or more applications 170 are optimally selected based on the user data 133, the diagnostic data 136, the network data 139, and the billing data 142.

At step 611, method 600 comprises selecting, by the pre-installation application 128 using a selection application 126 associated with the trained data model application 120 and executing at the data processing system 106, additional applications 171 to recommend for installation at the UE 103 based on post-setup engagement data 154 describing a usage of downloaded applications at the UE 103 over a predefined period of time after setup of the UE. At step 613, method 600 comprises transmitting, by the pre-installation application 128, to the UE 103, an updated manifest 151 including data describing the additional applications 171 and links for installing the additional applications 171.

Method 600 may include other steps and/or features that are not otherwise shown in FIG. 6. In an embodiment, the data model application 120 is trained using training data 163, and the training data 163 comprises first labelled datasets including historical data describing associations between one or more UEs 103 and applications installed at the one or more UEs and second labelled datasets indicating associations between different diagnostic data 136 and different user segments. In an embodiment, the user data 133 further comprises data tracking the user activity of the user across different applications and metatags describing user interactions and related content.

In an embodiment, transmitting, by the pre-installation application 128 using the pre-loading application 124, to the UE 103, a custom manifest 148 comprises determining, by the pre-installation application 128 using the pre-loading application 124, a quantity of the one or more applications 170 to pre-install at the UE 103 based on the user data 133, the diagnostic data 136, the network data 139, and the billing data 142 and a request parameter 157 received from an operator of the application system 111, and transmitting, by the pre-installation application 128, to the UE 103, a message indicating the quantity of the one or more applications 170 to pre-install at the UE 103. In an embodiment, after transmitting, by the pre-installation application 128, to the UE 103, the message indicating the quantity of the one or more applications 170 to pre-install at the UE 103, method 600 may further comprise selecting, by the pre-installation application 128 using the pre-loading application 124, the one or more applications 170 for pre-installation at the UE 103 based on the user data 133, the diagnostic data 136, the network data 139, and the billing data 142, adding, by the pre-installation application 128, the data describing the one or more applications 170 to pre-install at the UE 103 and links for installing the one or more applications 170 to the custom manifest 148, and storing, by the pre-installation application 128, the custom manifest 148 in association with the user identifier 130. In an embodiment, the one or more applications 170 are selected for pre-installation at the UE 103 further based on bids received from one or more enterprise systems.

FIG. 7 illustrates a computer system 700 suitable for implementing one or more embodiments disclosed herein. In an embodiment, the data processing system 106, application system 111, and/or UEs 103, etc., may each be implemented as the computer system 700. The computer system 700 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 700, at least one of the CPU 382, the RAM 388, and the ROM 386 are changed, transforming the computer system 700 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 700 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 700 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 700 to provide the functionality of a number of servers that is not directly bound to the number of computers in the computer system 700. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 700, at least portions of the contents of the computer program product to the secondary storage 384, to the ROM 386, to the RAM 388, and/or to other non-volatile memory and volatile memory of the computer system 700. The processor 382 may process the executable instructions and/or data structures in part by directly accessing the computer program product, for example by reading from a CD-ROM disk inserted into a disk drive peripheral of the computer system 700. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 700.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 700 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for dynamically pre-installing one or more applications at a user equipment (UE), wherein the method comprises:
receiving, by a pre-installation application executing at an application system, a request from the UE, wherein the request comprises diagnostic data and network data associated with the UE, wherein the diagnostic data describes an attribute of the UE, and wherein network data describes a location of the UE and a type of network connected to the UE;
determining, by the pre-installation application using an identification application associated with a trained data model application and executing at a data processing system, a user identifier of a user operating the UE based on at least one of the diagnostic data and billing data associated with the UE and obtained using the diagnostic data;
associating, by the pre-installation application, user data describing an application history of the user, the diagnostic data, the network data, and the billing data with the user identifier of the user;
transmitting, by the pre-installation application using a pre-loading application associated with the trained data model application and executing at the data processing system, to the UE, a custom manifest including data describing the one or more applications to pre-install at the UE and links for installing the one or more applications, wherein the one or more applications are optimally selected based on the user data, the diagnostic data, the network data, and the billing data;
selecting, by the pre-installation application using a selection application associated with the trained data model application and executing at the data processing system, additional applications to recommend for installation at the UE based on post-setup engagement data describing a usage of installed applications at the UE over a predefined period of time after setup of the UE; and
transmitting, by the pre-installation application, to the UE, an updated manifest including data describing the additional applications and links for installing the additional applications.

2. The method of claim 1, wherein the trained data model application is trained using training data, wherein the training data comprises first labelled datasets including historical data describing associations between one or more UEs and applications installed at the one or more UEs and second labelled datasets indicating associations between different diagnostic data and different user segments.

3. The method of claim 1, wherein transmitting, by the pre-installation application using the pre-loading application, to the UE, a custom manifest comprises:
determining, by the pre-installation application using the pre-loading application, a quantity of the one or more applications to pre-install at the UE based on the user data, the diagnostic data, the network data, and the billing data and a request parameter received from an operator of the application system; and
transmitting, by the pre-installation application, to the UE, a message indicating the quantity of the one or more applications to pre-install at the UE.

4. The method of claim 3, wherein after transmitting, by the pre-installation application, to the UE, the message indicating the quantity of the one or more applications to pre-install at the UE, the method further comprises:
selecting, by the pre-installation application using the pre-loading application, the one or more applications for pre-installation at the UE based on the user data, the diagnostic data, the network data, and the billing data;
adding, by the pre-installation application, the data describing the one or more applications to pre-install at the UE and links for installing the one or more applications to the custom manifest; and
storing, by the pre-installation application, the custom manifest in association with the user identifier.

5. The method of claim 4, wherein the one or more applications are selected for pre-installation at the UE further based on bids received from one or more enterprise systems.

6. The method of claim 1, wherein the user data further comprises data tracking user activity of the user across different applications and metatags describing user interactions and related content.

7. A communication system, comprising:
one or more non-transitory memories;
one or more processors communicatively coupled to the one or more non-transitory memories;
a pre-installation application stored at a first non-transitory memory, which when executed by a first processor, causes the first processor to be configured to train a data model application using training data, wherein the training data comprises labelled datasets including historical data describing associations between users and content that the users have engaged with across different applications; and
the data model application stored at a second non-transitory memory, which when executed by a second processor, causes the second processor to be configured to:
receive a request from a UE, wherein the request comprises diagnostic data and network data associated with the UE, wherein the diagnostic data describes one or more attributes of the UE, and wherein network data describes a location of the UE and a network connected to the UE; and
determine one or more applications for pre-installation at the UE based on the diagnostic data, the network data, billing data describing an account associated with the UE, and user data describing data, media, or interactive elements that a user or user segment has engaged with across different applications, and
wherein the pre-installation application is configured to:
generate a custom manifest including data describing the one or more applications to pre-install at the UE and links for installing the one or more applications; and
transmit the custom manifest to the UE.

8. The communication system of claim 7, wherein the UE is associated with a user that is an existing subscriber of a telecommunications carrier system, wherein the data model application is further configured to determine a user identifier of the user based on the billing data associated with the UE.

9. The communication system of claim 7, wherein the user of the UE is unknown to a telecommunications carrier system, wherein the data model application is further configured to determine a user segment of the user based the diagnostic data and billing data associated with the UE, and wherein the pre-installation application is further configured to associate the user with a user identifier based on the user segment.

10. The communication system of claim 7, wherein the pre-installation application is further configured to retrieve, from one or more databases in the communication system, the user data describing a history of applications downloaded by the user, data tracking the user activity of the user across different applications, and metatags describing user interactions and related content.

11. The communication system of claim 7, wherein the pre-installation application is further configured to associate the diagnostic data, the network data, the billing data, the user data, and the custom manifest with a user identifier of a user associated with the UE.

12. The communication system of claim 7, wherein the data model application is further configured to determine a quantity of the one or more applications to pre-install at the UE based on the user data, the diagnostic data, the network data, and the billing data and a request parameter received from an operator of the application system, and wherein the pre-installation application is further configured to transmit, to the UE, a message indicating the quantity of the one or more applications to pre-install at the UE.

13. The communication system of claim 7, wherein the custom manifest comprises at least one of package names for the one or more applications, installation rules and priorities, and application configuration data.

14. A method comprising:
receiving, by a pre-installation application executing an application system, a request from a user equipment (UE), wherein the request comprises diagnostic data and network data associated with the UE;
transmitting, by the pre-installation application using a data model application executing at a data processing system, to the UE, a custom manifest describing one or more applications for pre-installation and links to install the one or more applications at the UE, wherein the one or more applications are optimally selected based on the diagnostic data, the network data, and at least one of billing data describing an account associated with the UE, or user data describing data, media, or interactive elements that a user or user segment has engaged with across different applications; and
transmitting, by the pre-installation application using the data model application, to the UE, an updated manifest describing one or more additional applications to recommend for installation at the UE based on post-setup engagement data describing a usage of installed applications at the UE over a predefined period of time after setup of the UE.

15. The method of claim 14, further comprising training the data model application using training data, wherein the training data comprises datasets including historical data describing one or more UEs, users of the one or more UEs, network connections of the one or more UEs, and applications installed at the one or more UEs.

16. The method of claim 14, wherein the diagnostic data describes at least one of attributes of the UE or carrier metadata describing a telecommunications carrier linked to the UE, and wherein network data describes a location of the UE and a type of network connected to the UE.

17. The method of claim 14, further comprising retrieving, by the pre-installation application, from one or more databases in a communication system, the user data describing data, media, or interactive elements that the user or user segment has engaged with across different applications.

18. The method of claim 14, wherein when the UE is associated with the user that is an existing subscriber of a telecommunications carrier system, the method further comprises determining, by the data model application, a user identifier of the user based on billing data associated with the UE and indicating a user account of the user.

19. The method of claim 14, wherein when the user of the UE is unknown to a telecommunications carrier system, the method further comprises determining, by the data model application, a user segment of the user based the diagnostic data and billing data associated with the UE, and associating, by the pre-installation application, the user with a user identifier based on the user segment.

20. The method of claim 19, wherein the diagnostic data comprises a device identifier of the UE, and wherein the network data comprises an identifier of a network or cell site connected to the UE.
